(19) United States
(12) Patent Application Publication
(10) Pub. No.: US 2010/0077814 A1
(43) Pub. Date: Apr. 1, 2010

(54) SECURITY LOCK

(75) Inventors: Ambrogio MARTINO, Lanzo Torinese (Torino) (IT); Maurizio Franceschini, Cantalupa (Torino) (IT)

Correspondence Address: SUGHRUE MION, PLLC, 2100 PENNSYLVANIA AVENUE, N.W., SUITE 800, WASHINGTON, DC, 20037, US

(73) Assignee: GIOBERT S.P.A., RIVOLI (Torino) (IT)

(21) Appl. No.: 12/565,441

(22) Filed: Sep. 23, 2009

(30) Foreign Application Priority Data
Sep. 29, 2008 (IT) TO2008A000709

(51) Int. Cl. E05B 9/04

(52) U.S. Cl. 70/449

(57) ABSTRACT

The lock comprises: a fixed bush which defines a cylindrical cavity within which a cylinder rotating about the longitudinal axis of the cavity is mounted; a spring for retaining the cylinder within the cavity in the axial direction, the spring being interposed between a first circumferential groove made in the external lateral surface of the proximal portion of the cylinder and a facing slot made in the wall of the cavity; and interference means suitable for preventing the rotation of the cylinder within the cavity when the cylinder is pushed towards the distal extremity of the bush. A plurality of circumferentially spaced reliefs, extending each for an arc of a circle, radially protrude from a circumferential section of the external surface of the proximal portion of the cylinder, which reliefs bear in normal conditions against a circumferential flange which radially protrudes inwards from the internal surface of the bush. Moreover, a second circumferential groove flanking the first groove, from which it is separated by a circumferential wall, is made in the external lateral surface of the proximal portion of the cylinder.

The present invention relates to a lock, particularly for use in a motor vehicle.

In more detail, such a lock comprises:
a fixed bush which defines a cylindrical cavity within which a cylinder rotating about the axis of the cavity is mounted,
a spring for retaining the cylinder within the cavity in the axial direction, said spring being interposed between a first circumferential groove made in the external lateral surface of the proximal portion of the cylinder and a facing slot made in the wall of said cavity, and
interference means suitable for preventing the rotation of the cylinder within the cavity when, due to a break-in attempt, said cylinder is pushed towards the distal extremity of the bush.

A lock of this kind is described in patent application EP-A-1 632 624. This lock, owing to the presence of the aforementioned interference means, prevents the cylinder from rotating when the cylinder, as normally happens in break-ins, is pushed axially forcibly along the bush cavity as a means of illicitly operating the mechanical members located downstream.

However, even this kind of safety or security lock can be forced by removing the cylinder, or what remains of it, from the cavity after the initial action of pushing it inwards.

The object of the present invention therefore is to overcome the disadvantage indicated above of known locks.

This object is achieved by means of a lock of the type indicated at the outset of this description and characterized in that at least two circumferentially spaced reliefs, extending each for an arc of a circle, radially protrude from a circumferential section of the external surface of the proximal portion of the cylinder, said reliefs bearing in normal operating condition against a circumferential flange which radially protrudes inwards from the internal surface of the bush, and
in that a second circumferential groove flanking the first groove, from which it is separated by a circumferential wall, is made in the external lateral surface of the proximal portion of the cylinder.

In the lock of the invention, an attempt to force the lock will break the reliefs and push the cylinder forwards, causing the interference means to engage so that the cylinder cannot be rotated. At the same time, the forward movement of the cylinder causes the retaining spring to jump out of the first groove into the second, from where it can prevent, or at least significantly obstruct, subsequent attempts to extract the cylinder and gain free access to the mechanical components controlled by the cylinder.

The lock on which the security device of the present invention is mounted may advantageously also include other security devices. Clearly, however, the security device of the present invention may also be used on its own.

Other advantages and features of the present invention will become clear from the following detailed description, which is offered by way of example without implying any limitation and with reference to the accompanying drawings, in which:

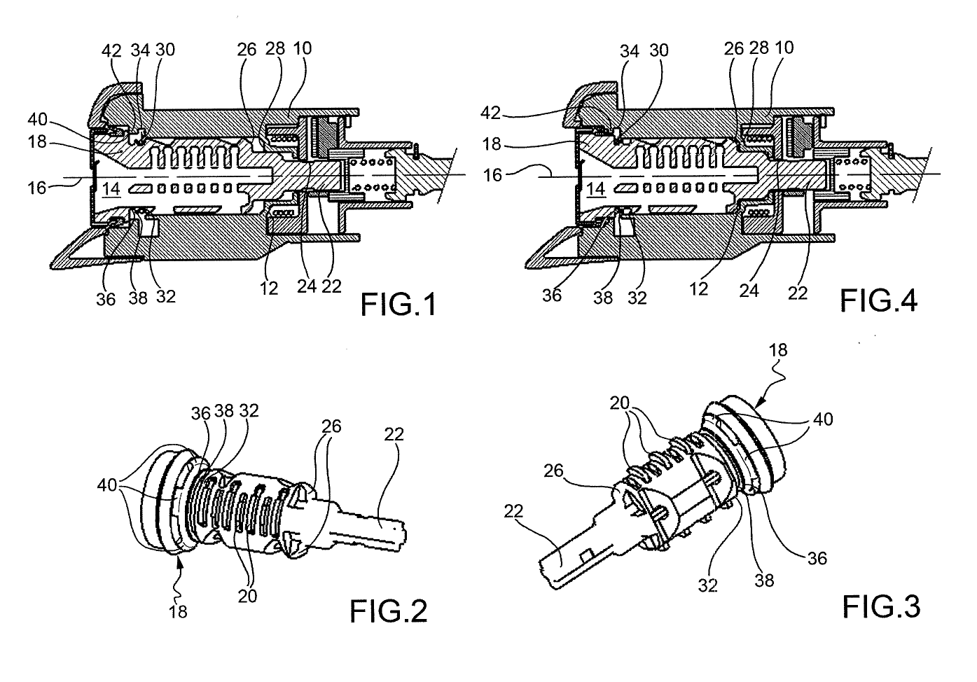

FIG. 1 is a longitudinal cross section through a lock of the invention in the normal working configuration,

FIG. 2 is a perspective view of the cylinder of the lock seen in FIG. 1,

FIG. 3 is a perspective view of the cylinder seen in FIG. 2, viewed from a different angle, and

FIG. 4 is a longitudinal cross section through the lock seen in FIG. 1 at an advanced stage of an attempted break-in.

A lock, especially for vehicular use, comprises (FIGS. 1-3) a fixed bush 10 closed by an end wall 12 in its distal region. The bush 10 defines in its interior a cylindrical cavity 14, rotating about the longitudinal axis 16 of which is a cylinder 18. The latter, in a manner known per se, contains multiple plates 20 which are movable radially, and it has a distal projection 22 which passes through a hole 24 in the end wall 12.

The cylinder 18 can be turned about the axis 16 once its key has been inserted in the key-way, which causes a radial movement of predetermined amplitude of the plates 20, which causes the cylinder to operate a bolt actuating member. These operating features and the associated structural details are well known to those skilled in the art and have little bearing on the present invention. They will not therefore be further described or illustrated.

Respective pluralities of circumferentially spaced relief elements 26, 28 protrude from the facing surfaces of the distal extremity of the cylinder 18 and of the end wall 12. The relief elements 26, 28 of each plurality are staggered with respect to those 28, 26 of the other plurality.

A spring 30 for retaining the cylinder 18 in the axial direction within the cavity 14 is interposed between a first circumferential groove 32 made in the external lateral surface of the proximal portion of the cylinder 18 and a facing circumferential groove 34 made in the wall of the cavity 14. The spring 30 is U-shaped and in normal operation of the lock prevents translational movement of the cylinder 18 in the axial direction, once the cylinder has been inserted in the cavity 14 during assembly of the lock.

A second circumferential groove 36 flanking the first groove 32, from which it is separated by a circumferential wall 38, is also made in the external lateral surface of the proximal portion of the cylinder 18. The second groove 36, which is further than the first groove 32 from the central part of the cylinder 18, performs no function during normal operation of the lock.

Circumferentially spaced reliefs 40 protrude radially from a circumferential section of the external surface of the proximal portion of the cylinder 18 which is further than the second grooves 32, 36 from the central part of the cylinder 18, and each extends for an arc of a circle. The reliefs 40, which are advantageously spaced out at equal intervals and are four in number, bear against a circumferential flange 42 which radially protrudes inwards from the internal surface of the bush 10.

In normal operation of the lock, the relief elements 26, 28 on the facing surfaces of the distal end of the cylinder 18 and of the end wall 12 are axially disengaged, as described in detail in EP-A-1 632 624, which should be consulted for further details. In this way, once the key is in the keyway, the cylinder 18 can rotate freely and cause the downstream members to move.

As a result of an attempted break-in using a screwdriver and hammer on the cylinder 18, the radial reliefs 40 are broken first. Since the latter are now no longer acting against the flange 42, the cylinder 18 moves translationally forwards towards the distal end of the cavity 14. This movement (FIG. 4) causes the relief elements 26, 28 protruding from the facing surfaces of the distal end of the cylinder 18 and of the end wall 12 to inter-penetrate with each other, forming a continuous annular structure. Rotation of the cylinder 18, and hence operation of the bolt, is thus prevented.

At the same time, the forward translational movement of the cylinder 18 moves the spring 30 from the first groove 32 to the second 36. The spring 30 is thus now interposed between the latter and the circumferential groove 34 and obstructs any rearward translational movement of the cylinder 18. This greatly increases the security of the lock, because once the thief realizes that the cylinder 18 cannot be turned because of the engagement between the relief elements 26, 28, he will typically try to withdraw the cylinder 18 from the cavity 14 to allow him to work directly on the actuating members controlled by the cylinder. In the lock of the invention, however, it is not possible to withdraw it, or at any rate it will take much longer to do so, because of the spring 30 trapped in its new seat between the second groove 36 and the slot 34. The security of the lock is thereby enhanced.

Clearly, without departing from the principle of the invention, the details of construction and the embodiments could vary considerably from those described duly by way of example, without thereby departing from its scope.

What is claimed is:

1. Lock comprising:
a fixed bush which defines a cylindrical cavity within which a cylinder rotating about the longitudinal axis of the cavity is mounted,
a spring for retaining the cylinder within the cavity in the axial direction, said spring being interposed between a first circumferential groove made in the external lateral surface of the proximal portion of the cylinder and a facing slot made in the wall of said cavity, and
interference means suitable for preventing the rotation of the cylinder within the cavity when, due to a break-in attempt, said cylinder is pushed towards the distal extremity of the bush,
said lock being characterized in that at least two circumferentially spaced reliefs, extending each for an arc of a circle, radially protrude from a circumferential section of the external surface of the proximal portion of the cylinder, said reliefs bearing in normal operating condition against a circumferential flange which radially protrudes inwards from the internal surface of the bush, and
in that a second circumferential groove flanking the first groove, from which it is separated by a circumferential wall, is made in the external lateral surface of the proximal portion of the cylinder.

2. Lock according to claim 1, characterized in that said interference means are constituted by at least one respective relief element axially extending from facing surfaces of the distal extremity of the cylinder and of an end wall closing the distal extremity of the cavity, said relief elements being suitable for interfering with each other and thus preventing the rotation of the cylinder when said cylinder is pushed towards the distal extremity of the bush due to a break-in attempt.

3. Lock according to claim 2, characterized in that respective pluralities of circumferentially spaced relief elements protrude from the facing surfaces of the distal extremity of the cylinder and of the end wall, the relief elements of each plurality being staggered with respect to those of the other plurality, in such a way that the displacement of the cylinder towards the distal extremity of the bush brings about, due to the inter-penetration of said relief elements, the formation of a continuous annular structure.

4. Lock according to any one of the previous claims, characterized in that said circumferentially spaced reliefs which radially protrude from a circumferential section of the external surface of the proximal portion of the cylinder are four.

5. Lock according to claim 4, characterized in that said reliefs are spaced out at equal intervals.
